(19) United States
(12) Patent Application Publication
(10) Pub. No.: US 2002/0033800 A1
(43) Pub. Date: Mar. 21, 2002

(54) Computer system

(76) Inventor: Carlos Cabrera JR., New York, NY (US)

Correspondence Address: Matthew J. Peirce, Esq., 1550 Starlight Canyon Avenue, Las Vegas, NV, 89123, US

(21) Appl. No.: 09/961,132

(22) Filed: Sep. 20, 2001

Related U.S. Application Data
(60) Provisional application No. 60/233,898, filed on Sep. 20, 2000.

(51) Int. Cl. G09G 5/00; G01C 21/26

(52) U.S. Cl. 345/156; 701/200

(57) ABSTRACT

A new and improved computer system is disclosed that would be used by a taxi company or similar company which would allow a taxi driver to have instant access to information as needed. The computer system would comprise a main computer and a plurality of device screens. The main computer would likely be located at a dispatch center, while each taxicab would have a device screen which would allow a taxi driver to save, delete, and view information as needed. The taxi driver would also be able to print reports from the device screen as needed, and would also be able to view road maps to aid the taxi driver in finding locations. The present invention would preferably work with the AGS driver computer system, but could also be designed to work any software design.

### I. BACKGROUND OF THE INVENTION

The present invention concerns that of a new and improved computer system that would be used by a taxi company or similar company which would allow a taxi driver to have instant access to information as needed.

### II. DESCRIPTION OF THE PRIOR ART

U.S. Pat. No. 5,732,074, issued to Spaur et al., discloses an invention wherein communication of information including data between a remote computer and a vehicle is managed and facilitated using an apparatus compatible with standardized network communication links.

U.S. Pat. No. 5,684,860, issued to Milani et al., discloses an apparatus for automatically distributing communications between users and a fleet of mobile stations through a central station.

U.S. Pat. No. 5,604,676, issued to Penzias, discloses an invention wherein door-to-door transportation is provided in a nearly on-demand manner by employing a set of multipassenger vehicles, such as vans, whose routes are continuously updated.

### III. SUMMARY OF THE INVENTION

The present invention concerns that of a new and improved computer system that would be used by a taxi company or similar company which would allow a taxi driver to have instant access to information as needed. The computer system would comprise a main computer and a plurality of device screens. The main computer would likely be located at a dispatch center, while each taxicab would have a device screen which would allow a taxi driver to save, delete, and view information as needed. The taxi driver would also be able to print reports from the device screen as needed, and would also be able to view road maps to aid the taxi driver in finding locations. The present invention would preferably work with the AGS driver computer system, but could also be designed to work any software design.

There has thus been outlined, rather broadly, the more important features of a computer system for taxi drivers or other hired drivers in order that the detailed description thereof that follows may be better understood and in order that the present contribution to the art may be better appreciated. There are, of course, additional features of the computer system for taxi drivers or other hired drivers that will be described hereinafter and which will form the subject matter of the claims appended hereto.

In this respect, before explaining at least one embodiment of the computer system for taxi drivers or other hired drivers in detail, it is to be understood that the computer system for taxi drivers or other hired drivers is not limited in its application to the details of construction and to the arrangements of the components set forth in the following description or illustrated in the drawings. The computer system for taxi drivers or other hired drivers is capable of other embodiments and being practiced and carried out in various ways. Also, it is to be understood that the phraseology and terminology employed herein are for the purpose of descriptions and should not be regarded as limiting.

As such, those skilled in the art will appreciate that the conception, upon which this disclosure is based, may readily be utilized as a basis for the designing of other structures, methods and systems for carrying out the several purposes of the present computer system for taxi drivers or other hired drivers. It is important, therefore, that the claims be regard as including such equivalent constructions insofar as they do not depart from the spirit and scope of the present invention.

It is therefore an object of the present invention to provide a computer system for taxi drivers or other hired drivers which has all of the advantages of the prior art and none of the disadvantages.

It is another object of the present invention to provide a computer system for taxi drivers or other hired drivers which may be easily and efficiently manufactured and marketed.

It is another object of the present invention to provide a computer system for taxi drivers or other hired drivers which is of durable and reliable construction.

It is yet another object of the present invention to provide a computer system for taxi drivers or other hired drivers which is economically affordable and available to the buying public.

It is yet another object of the present invention to provide a computer system for taxi drivers or other hired drivers which provides additional benefits not present in the prior art.

Other objects, features and advantages of the present invention will become more readily apparent from the following detailed description of the preferred embodiment when considered with the attached drawings and appended claims.

### IV. BRIEF DESCRIPTION OF THE DRAWINGS

FIG. 1 shows a front view of a device screen of the present invention.

FIG. 2 shows a front view of a device screen of the present invention showing a map being presented.

### V. DESCRIPTION OF THE PREFERRED EMBODIMENT

The present invention concerns that of a new and improved computer system 2 that would be used by a taxi company or similar company which would allow a taxi driver to have instant access to information as needed. The computer system 2 would comprise a main computer 4 and a plurality of device screens 6. The main computer 4 would likely be located at a dispatch center 7, while each taxi 8 would have a device screen 6 which would allow a taxi driver to save, delete, and view information as needed. The taxi driver would also be able to print reports from the device screen 6 as needed, and would also be able to view road maps to aid the taxi driver in finding locations. The present invention would preferably work with the AGS driver computer system, but could also be designed to work any software design.

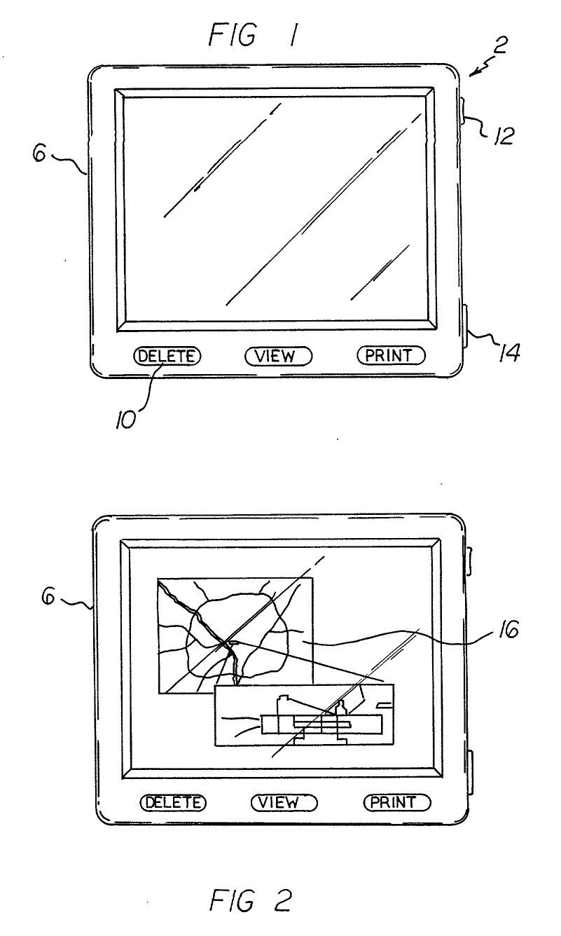

FIG. 1 shows a front view of a device screen 6 of the present invention. Device screen 6 has a configuration which would allow for the display of the date and time and would have various buttons 10 on its front face. In addition, device screen 6 would also have side-mounted on/off button 12 and side-mounted printer port 14. Printer port 14 would connect up with a portable printer (not shown) which would allow a taxi driver to print out lists of instructions from the dispatch center or a map.

The configuration and layout of device screen 6 shown in FIG. 1 is not meant to be limiting, but rather is meant to show some of the possible options that device screen 6 might have. A device screen 6 used with the present invention may have additional items not discussed herein, or may not have all of the items suggested herein.

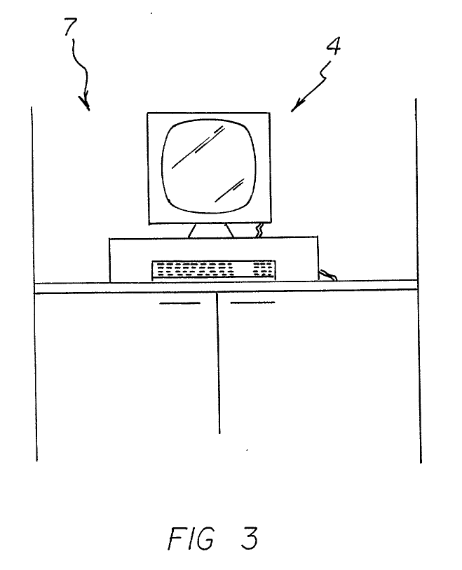

FIG. 2 shows a front view of a device screen of the present invention showing a map 16 being presented. Map 16 could then be printed out if desired by a user.

FIG. 3 shows a main computer 4 located in a dispatch center 7. Main computer 4 would have an incorporated transmitter which would be able to send commands via radio waves to one or more particular device screens 6 so that the dispatch center 7 could give proper instructions to a particular taxi driver. Each device screen 6 would have an incorporated radio wave receiver so that it could pick up transmitted signals from the main computer 4.

What I claim as my invention is:

1. A computer system for taxi drivers or other hired drivers comprising:
(a) a main computer, the main computer preferably located at a central location, the main computer including a radio wave transmitter capable of transmitting radio waves to at least one device screen, and
(b) a plurality of device screens, each device screen including a radio wave receiver, the radio wave receiver capable of receiving and displaying information received from the transmitter on the main computer, each device screen being located within a taxi or other hired vehicle, each device screen including a front-mounted screen, each device screen further including a plurality of front-mounted operations buttons, each device screen further including an on/off button, and each device screen further including a printer port.

2. A computer system for taxi drivers or other hired drivers according to claim 1 wherein the plurality of front-mounted operations buttons on the device screen would include a delete button.

3. A computer system for taxi drivers or other hired drivers according to claim 1 wherein the plurality of front-mounted operations buttons on the device screen would include a print button.

4. A computer system for taxi drivers or other hired drivers according to claim 1 wherein the plurality of front-mounted operations buttons on the device screen would include a view button.

5. A computer system for taxi drivers or other hired drivers according to claim 1 wherein the on/off button would be side-mounted on each device screen.

6. A computer system for taxi drivers or other hired drivers according to claim 1 wherein the printer port would be side-mounted on each device screen.

7. A computer system for taxi drivers or other hired drivers according to claim 1 in combination with at least one printer, the printer being electronically connected to the printer port on a device screen.

8. A computer system for taxi drivers or other hired drivers according to claim 1 wherein the software used for the computer system would be the AGS driver computer system.

9. A computer system for taxi drivers or other hired drivers according to claim 1 wherein the information displayed on a device screen would include reports.

10. A computer system for taxi drivers or other hired drivers according to claim 1 wherein the information displayed on a device screen would include road maps.
